(19) United States
(12) Patent Application Publication
(10) Pub. No.: US 2026/0094421 A1
(43) Pub. Date: Apr. 2, 2026

(54) METHOD AND APPARATUS FOR BUILDING ARTIFICIAL INTELLIGENCE MODEL PIPELINE BASED ON MULTI-TASK CONSISTENCY

(71) Applicants: HYUNDAI MOTOR COMPANY, Seoul (KR); Kia Corporation, Seoul (KR)

(72) Inventor: Hyeong Gyu KIM, Hwaseong-si (KR)

(73) Assignees: HYUNDAI MOTOR COMPANY, Seoul (KR); Kia Corporation, Seoul (KR)

(21) Appl. No.: 19/068,625

(22) Filed: Mar. 3, 2025

(30) Foreign Application Priority Data
Oct. 2, 2024 (KR) 10-2024-0133809

(51) Int. Cl. G06V 10/776; G06V 10/764; G06V 10/774; G06V 10/82; G06V 10/94; G06V 20/56

(52) U.S. Cl. CPC G06V 10/776; G06V 10/764; G06V 10/774; G06V 10/82; G06V 10/955; G06V 20/56

(57) ABSTRACT

A method for building a model pipeline includes calculating a derived distance map of an object detected by a first head performing a first task and an output distance map of the object detected by a second head performing a second task. The method further includes calculating an inconsistency loss based on the derived and output distance maps, applying the inconsistency loss to the loss function of an artificial intelligence model performing the first and second tasks, and adjusting parameters of the model based on the loss function incorporating the inconsistency loss.

### CROSS REFERENCE TO RELATED APPLICATION

The present application claims the benefit of priority to Korean provisional Application No. 10-2024-0133809, filed Oct. 2, 2024, the entire contents of which are incorporated by reference for all purposes.

### TECHNICAL FIELD

The present disclosure relates to a method and apparatus for building an artificial intelligence model pipeline based on multi-task consistency, and more specifically, to a method and apparatus for building an artificial intelligence model pipeline by utilizing loss and uncertainty derived from the consistency between the output results of tasks (task consistency).

### BACKGROUND

The matters described in this Background section are only for enhancement of understanding of the background of the disclosure, and should not be taken as acknowledgment that they correspond to prior art already known to those skilled in the art. Recent deep learning-based cognitive models for autonomous driving may output spatial information of the surrounding environment. For example, the cognitive model may primarily provide 3D information and operable space information of agents around an ego-vehicle to generate a safe path for a mobility device performing autonomous driving.

Therefore, the cognitive model must simultaneously perform object recognition (3D object detection) and free space estimation (3D free space) tasks to provide both 3D information and operable space information.

Accordingly, attempts are being made to use a single artificial intelligence model in which task-specific heads share a common encoder to efficiently compute 3D information and operable space information (i.e., multi-task learning, MTL).

In addition, since a large amount of data about the surrounding space is required to infer various information about the space, the trend is to use MCF (Monte Carlo Fusion) or MMF (Multi Modal Fusion) methodologies that fuse data acquired from multiple sensors and then comprehensively process it.

For example, MMF or MTL methodologies may be used to embed data acquired from each sensor into individual deep learning models, combine them in a bird's-eye view (BEV), and then perform multi-tasks from branched networks.

However, in the case of the MTL methodology, an advantage is that the performance of the entire task increases by sharing data for individual tasks and utilizing it for parameter learning of the backbone that shares them, but there is a limitation in that the efficiency decreases in the independent performance of the individual tasks depending on the correlation between tasks. In other words, compared to STL (Single Task Learning) that learns individual tasks, a negative transfer may occur in which the performance of each task decreases.

Accordingly, an active learning pipeline design strategy that accounts for MTL characteristics is required to continuously improve performance.

### SUMMARY

An object of the present disclosure is to provide a method and apparatus for building an artificial intelligence model pipeline based on multi-task consistency, which builds a pipeline for designing an artificial intelligence model by utilizing loss and uncertainty based on the consistency between output results of tasks (task consistency).

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

According to one or more example embodiments of the present disclosure, a method performed by an apparatus may include: calculating a derived distance map of an object detected by a first head performing a first task and calculating an output distance map of the object detected by a second head performing a second task, calculating an inconsistency loss based on the derived distance map and the output distance map, reflecting the inconsistency loss to a loss of an artificial intelligence model performing the first task and the second task and setting parameters of the artificial intelligence model to be modified based on the loss reflecting the inconsistency.

The method may further comprise: calculating a first uncertainty and a second uncertainty according to each performing result based on results of performing the first and second tasks of the artificial intelligence model and selecting learning data based on at least one of the first uncertainty, the second uncertainty or a consistency-based uncertainty, wherein the consistency-based uncertainty is calculated based on the derived distance map and the output distance map.

The derived distance map may be calculated by angle from a cuboid box for the object on a bird's-eye view output by the first head.

The output distance map may represent a distance to the nearest object for each angle on a bird's-eye view calculated by the second head.

The calculating the inconsistency loss may comprise calculating the inconsistency loss based on the derived distance map and the output distance map for the object satisfying a predefined correlation for a similarity of a class among the objects detected by the first head and the second head.

The inconsistency loss may be calculated based on at least one of a loss based on a scalar value of the derived distance map and the output distance map, a loss based on an endpoint of the derived distance map and the output distance map with a predetermined reference point as a starting point, and a loss based on a corresponding class.

The first uncertainty may be calculated based on an uncertainty about geometry of a cuboid box on a bird's-eye view output by the first head and a distribution of a class of the object to which the cuboid box refers.

The second uncertainty may be calculated based on at least one of an uncertainty about a boundary of the object on a bird's-eye view output by the second head or a distribution of a class of the object to which the boundary refers.

The consistency-based uncertainty may be calculated based on at least one of an uncertainty based on a scalar value of the derived distance map and the output distance map, an uncertainty based on an endpoint of the derived distance map and the output distance map with a predetermined reference point as a starting point, and an uncertainty based on a corresponding class.

Selecting the learning data may comprise selecting data input to the artificial intelligence model as the learning data when at least one of the first uncertainty, the second uncertainty, or the consistency-based uncertainty is greater than or equal to a predetermined threshold.

According to one or more example embodiments of the present disclosure, the apparatus may comprise: a memory configured to store at least one instruction and a processor configured to execute the at least one instruction stored in the memory based on data acquired from the memory, wherein the processor may configured to: calculate a derived distance map of an object detected by a first head performing a first task and calculate an output distance map of the object detected by a second head performing a second task, calculate an inconsistency loss based on the derived distance map and the output distance map, reflect the inconsistency loss in a loss of an artificial intelligence model performing the first task and the second task and set parameters of the artificial intelligence model to be modified based on the loss reflecting the inconsistency.

The effects obtainable from the present disclosure are not limited to the above-mentioned effects, and other effects not mentioned herein will be clearly understood by those skilled in the art from the following descriptions.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an example diagram schematically showing modules constituting an apparatus implementing a method of building an artificial intelligence model pipeline based on multi-task consistency according to an embodiment of the present disclosure.

FIG. 2 illustrates an example flowchart showing a method of building an artificial intelligence model pipeline based on multi-task consistency according to another embodiment of the present disclosure.

FIG. 3 illustrates an example diagram visually showing a difference caused by a calculated derived distance map and an output distance map.

FIG. 4 illustrates an example flowchart of a process of selecting learning data for training an artificial intelligence model in a pipeline according to the present disclosure.

FIG. 5 illustrates an example diagram modularly illustrating a process of processing a pipeline according to the present disclosure.

FIG. 6 illustrates an example diagram exemplifying an artificial intelligence model learning process and a learning data collection process to which a pipeline according to the present disclosure is applied.

FIG. 7 illustrates an example diagram illustrating a mobility device communicating with another device to transmit and receive data.

FIG. 8 illustrates an example diagram schematically showing modules constituting a mobility device according to the present disclosure.

### DESCRIPTION OF THE PREFERRED EMBODIMENTS

Hereinafter, examples of the present disclosure are described in detail with reference to the accompanying drawings so that those having ordinary skill in the art may easily implement the present disclosure. However, examples of the present disclosure may be implemented in various ways and thus the present disclosure is not limited to the examples described herein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the methods of attaining them should become apparent to those of ordinary skill in the art with reference to examples of the present disclosure described below in detail in conjunction with the accompanying drawings. The examples of the present disclosure, however, may be embodied in many different forms and should not be construed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and when drawings illustrated in the present specification are inverted, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

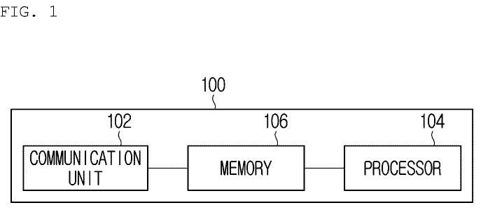

Hereinafter, with reference to FIG. 1, modules constituting an apparatus implementing a method of building an artificial intelligence model pipeline according to an embodiment of the present disclosure and a method of performing processing based on the built pipeline will be described. FIG. 1 is a diagram schematically showing constituting modules an apparatus implementing a method of building an artificial intelligence model pipeline based on multi-task consistency according to an embodiment of the present disclosure.

Referring to FIG. 1, the apparatus 100 (hereinafter referred to as a server) implementing a method of building an artificial intelligence model pipeline based on consistency may include a communication unit 102, a processor 106, and a memory 104. Each component is not an essential component, and may have additional components or be omitted, and a single component may be included in or combined with another component so that the single component may perform multiple functions. For example, without conflicting with the following description, a separate module may be added that collects learning data using an artificial intelligence model whose learning has been completed based on a pipeline built outside of the processor 106. The module may be merged into the processor 106 to perform processing for collecting learning data in the processor 106. As an example, the server 100 may additionally have a collection module 116 to perform tasks such as object detection, semantic segmentation, depth estimation, free space estimation. The tasks performed through the collection module 116 are not limited to the examples described above.

Additionally, the processor 106 may include a plurality of modules implementing a method of building an artificial intelligence model pipeline based on multi-task consistency according to another embodiment of the present disclosure. Hereinafter, the processor 106 may be referred to as the server 100 or used interchangeably for convenience of explanation.

Referring to FIG. 1, the server 100 may build a pipeline that calculates a distance from the result of each task to a detected object from an artificial intelligence model capable of performing multiple tasks, calculates a loss based on the calculated distance, and reflects the calculated loss to the loss of the artificial intelligence model to train the artificial intelligence model. In addition, the server 100 may build a pipeline that distributes a trained artificial intelligence model and acquires additional learning data based on the results of performing each task of the distributed artificial intelligence model to update it. The server 100 may train the artificial intelligence model based on the built pipeline and update the trained artificial intelligence model using the acquired additional learning data. The server 100 may implement a pipeline to acquire additional learning data internally without distributing the trained artificial intelligence model to a separate device and may select or acquire learning data autonomously.

The server 100 may utilize an artificial intelligence model designed to perform multiple tasks, with a head for each task and each head sharing a single backbone. Specifically, the artificial intelligence model may encode input data into a bird's-eye view and perform an appropriate task based on the encoded bird's-eye view. For example, the artificial intelligence model may perform tasks such as object detection, semantic segmentation, depth estimation, pose estimation, and free space estimation using the bird's-eye view. The encoded bird's-eye view may mean bird's-eye view features generated based on features inferred from the input data. The tasks capable of being performed by the server 100 are not limited to the examples described above.

Specifically, the artificial intelligence model according to the present disclosure may be an artificial intelligence model including an encoder that analyzes the context of video data to generate features. The encoder may employ an image analysis model capable of simultaneously processing a plurality of video data and generating a plurality of features. As an example, the image analysis model may include a model that employs a CNN (Convolutional Neural Network) structure, a YOLO (You Only Look Once), an R-CNN (Regions with Convolutional Neural Network), or a transformer structure, but is not limited to the examples described above. Additionally, the encoder may generate bird's-eye features based on the generated features.

The model referred to in the present disclosure may be variously referred to as a network, a neural network, a learning model, an artificial neural network, an artificial intelligence model, and a deep learning model. In addition, the artificial intelligence model used in the present disclosure may be partially trained and fine-tuned.

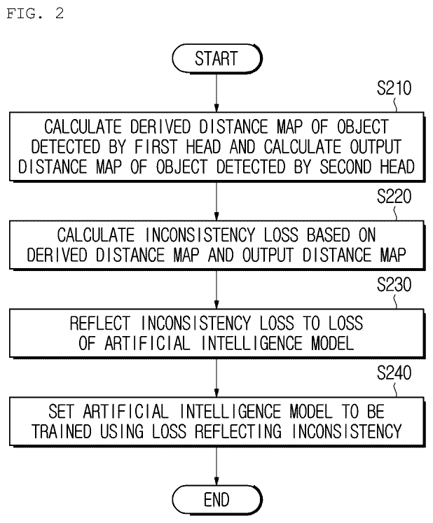

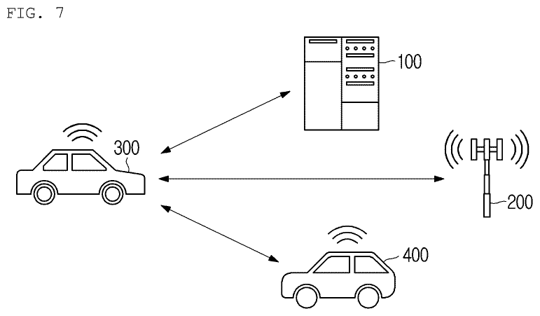

The server 100 may distribute the trained artificial intelligence model to another device through the learning module 108 to obtain additional learning data. For example, the server 100 may distribute, to a mobility device (see 300 of FIG. 7), the collection module 116, which performs processing to select learning data through the trained artificial intelligence model. The collection module 116 may perform a task using data acquired according to driving of the mobility device 300, and may also perform processing to select learning data from among the acquired data based on the built pipeline. The above-described processing will be described in detail with reference to FIGS. 2 to 6.

The mobility device 300 refers to a device that may move to a specific point. The mobility device 300 may be any one of devices such as a ground vehicle that drives on the ground, a mobile robot that is autonomously or remotely controlled, a work robot for a specific purpose, etc. Additionally, the mobility device 300 is not limited to a ground mobility device, and may be, for example, an air mobility device, a water mobility device for water transportation, or an underwater mobility device (e.g., a submarine). The mobility device 300 may operate autonomously or manually. The mobility device 300 that is driven autonomously may be implemented as semi-autonomous driving or fully autonomous driving. Fully autonomous driving refers to autonomous operation where the controller of the mobility device 300 fully manages control without user intervention, even in uncertain driving situations. Semi-autonomous driving may be provided as autonomous driving that requires driver intervention depending on a specific driving situation. Semi-autonomous driving may be implemented by allowing the user to drive manually by having the controller of the mobility device 300 deactivate autonomous driving when the above situation occurs and transfer control to the user. According to the levels of autonomous driving defined by the Society of Automotive Engineers (SAE), semi-autonomous driving corresponds to autonomous driving levels 1 to 4, and fully autonomous driving corresponds to level 5.

The server 100 may be, for example, a device, such as a server, provided separately from the mobility device 300 to be operated by a vehicle manufacturer or a management agency providing autonomous driving services. If the server 100 is a server operated by a vehicle manufacturer or management agency supporting autonomous driving, it may receive connected data of the mobility device 300 or transmit data required for autonomous driving. In order to support autonomous driving and various services of the mobility device 300, the server 100 may transmit various information and software modules used for controlling the mobility device 300 to the mobility device 300 in response to requests and data transmitted from the mobility device 300 and a user device. This disclosure mainly describes the server 100's processing related to building an artificial intelligence model pipeline based on multi-task consistency, according to another embodiment.

The communication unit 102 of the server 100 may support mutual communication with the mobility devices 300 and 400, a ITS device 300, etc. In the present disclosure, the communication unit 102 may be a communication interface that receives various data and networks (or algorithms) used to generate (or learn) an artificial intelligence model that supports driving and convenience functions of the mobility device 300, and transmits information and networks related to the artificial intelligence model to the mobility device 300. In addition, the communication unit 102 may be a communication module that receives data generated or stored during driving from the mobility device 300, and transmits information supporting driving, such as map information, environmental information recognizing objects around the mobility device 300, traffic information, weather information, etc. to the mobility device 300. The communication unit 102 may serve as a communication module transmitting applications related to driving and convenience functions.

The memory 104 stores a program and various data for controlling the server 100, and may load a program or read and record data at the request of the processor 106. The memory 104 may manage image data, which is learning data used in an artificial intelligence model, and video data, which is sequential image data. The video data may include multi-view image data including distortion acquired by cameras 204b mounted at multiple locations of the mobility device 300 centered on the mobility device 300. In addition, the memory 104 may receive, store and manage learning data acquired through the distributed collection module 116 through the communication unit 106.

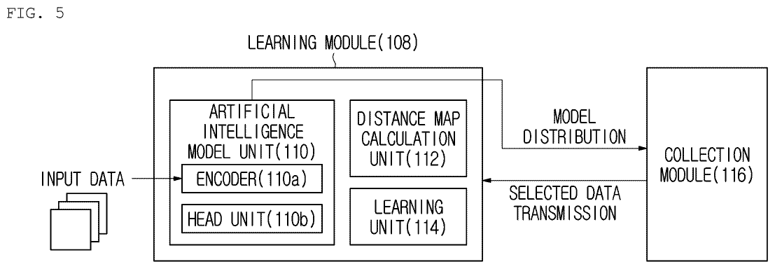

The learning module 108 may be configured to include functional modules 110, 112 and 114 illustrated in FIG. 5, which will be described later. The collection module 116 may be equipped with an artificial intelligence model learned through the learning module 108 and a functional module that additionally selects learning data through the artificial intelligence model.

The video data may include images collected from multiple mobility devices 300 and 400 and/or a DB for typical learning data, depth maps, depth information provided in a point cloud format, etc. In addition to the data described above, the memory 104 may also store applications for implementing driving and convenience functions of the mobility device 300, map information, traffic information, weather information, and other various information affecting driving.

The processor 106 may perform overall control of the server 100. The processor 106 may be configured to execute applications and instructions stored in the memory 104. Specifically, the processor 106 may build a pipeline to calculate a derived distance map of an object detected by a first head performing a first task of an artificial intelligence model using video data as input data, calculate an output distance map of an object detected by a second head performing a second task, calculate an inconsistency loss based on the derived distance map and the output distance map, and reflect the inconsistency loss to the loss of the artificial intelligence model and modify the parameters of the artificial intelligence model based on this, or performs the processing described above. The first and second described above do not limit the number of tasks and the number of heads that may be performed by the artificial intelligence model. In addition, the processor 106 may build a pipeline to calculate first and second uncertainties according to each performing result based on the performing results of the first and second tasks and select learning data based on at least one of the first and second uncertainties or the consistency-based uncertainty, or perform the processing described above.

Additionally, the processor 106 may receive feedback information according to the operation of the collection module 116 distributed to the mobility devices 300 and 400 and the same data as the video data from the mobility devices 300 and 400, and update the artificial intelligence model based on the received information and data. The processor 106 may distribute the updated artificial intelligence model or the collection module 116, which includes the updated artificial intelligence model, to the mobility devices 300 and 400.

Additionally, the processor 106 may perform processing to support driving and convenience functions of the mobility device 300. In the present disclosure, the processor 106 may be implemented as a single processing module, for example. As another example, the processing according to the above-described matters may be distributed and processed in a plurality of processing modules, and the processor 106 may be referred to collectively as a plurality of processing modules in the present disclosure.

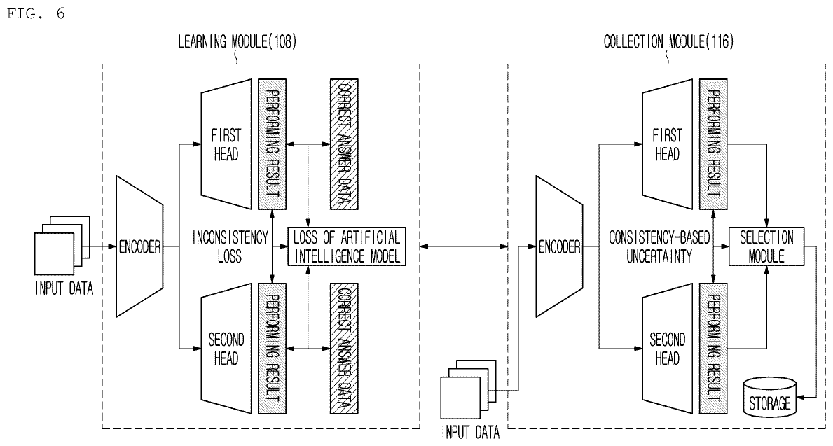

Hereinafter, a method of building an artificial intelligence model pipeline based on multi-task consistency according to another embodiment of the present disclosure will be described in detail with reference to FIGS. 2 and 6.

FIG. 2 is a flowchart illustrating a method for building an artificial intelligence model pipeline based on multi-task consistency, according to another embodiment of this disclosure, and FIG. 5 is a diagram modularly illustrating the pipeline processing described in this disclosure. A method of building an artificial intelligence model pipeline based on multi-task consistency in FIG. 5 and a model that practically implements processing based on the pipeline may be a software module processed by the processor 106, and the processor 106 may process requests from the modules listed in FIG. 5.

In this disclosure, the processing of the learning module 108 according to the embodiment is mainly described as being performed only in the server 100. However, the learning module 108 described below may be distributed and processed in the server 100 and other devices, as long as it does not conflict with the description below. The other devices may be, for example, other servers and/or the mobility devices 300 and 400. Likewise, the processing of the collection module 116 is mainly described as being performed only in the mobility devices 300 and 400, but may be distributed and processed in the server 100 and other devices within the scope that does not conflict with the description described below. Hereinafter, the processor 106 of the server 100 may be simply referred to as the server 100 for convenience of description, or these terms may be used interchangeably.

Referring to FIG. 2, the processor 106 of the server 100 calculates a derived distance map of an object detected by a first head of a head unit 110b included in an artificial intelligence model unit 110, and also calculates an output distance map detected by a second head (S210). The artificial intelligence model unit 110, as described in this disclosure, may be configured with an encoder 110a and the head unit 110b, which includes a head for each task performed. For example, the encoder 110a may analyze input data to generate features, and may also generate a bird's-eye view or a bird's-eye view feature based on the generated features. For example, when a CNN (convolutional neural network) structure is used as the encoder 110a, the features may mean a feature map that analyzes the features of input image data. As another example, when a transformer structure is used as the encoder 110a, the features may mean information on each patch of image data divided into predetermined patches, a relationship between patches, a global image context including the context of the image, etc. The structure that may be employed as the encoder 110a is not limited thereto, and may include all artificial neural network structures that may be used as a premise for performing tasks such as object detection, semantic segmentation, depth estimation, pose estimation, and free space estimation within the scope that does not conflict with the present disclosure. As an example, the encoder 110a may generate a radial BEV or a radial BEV feature based on the generated features. The radial BEV according to the present disclosure may be described interchangeably with a radial BEV grid. As another example, the processing of generating the radial BEV or radial BEV feature by the encoder 110a may be omitted.

For example, the first head of the head unit 110b may perform an object recognition task using features generated from the encoder 110a, and the second head may perform a free space estimation task. The tasks performed by the first and second heads are not limited to the examples described above, and the number of tasks processed by the artificial intelligence model unit 110 is also not limited.

The result of the first task performed by the first head may include information about the object detected on the radial bird's-eye view. For instance, it may include the classes of the objects on the radial bird's-eye view. For example, the result of performing the first task may include classes of the objects on the radial bird's-eye view. For example, the result of performing the first task may include information about the categorical distribution of the classes of the objects. In addition, for example, the result of performing the first task may include a boundary including information about the geometry of the detected object. For example, the result of performing the first task may provide the boundary of the detected object as a cuboid box, a bounding box, a polygon, or the like. For example, the cuboid box may include information about the geometry of the object, such as a radial distance, an azimuth angle, and an elevation, on the bird's-eye view. In addition, the cuboid box may include coordinates of the detected object on a three-dimensional coordinate plane or an orientation, such as yaw, pitch, and roll. The first head may be equipped with a plurality of heads to obtain each of the above-described performing results, for example, the first head may be composed of a head that outputs distribution information for classes and a head that calculates a cuboid box including information about geometry. In addition, the first head may additionally be equipped with a head that calculates uncertainty about information included in the cuboid box (cuboid box uncertainty).

The processor 106 calculates a derived distance map based on the result of performing the first task through a request or control of a distance map calculation unit 112. Specifically, the processor 106 calculates an intersection between a cuboid box expressing a boundary of an object detected on a bird's-eye view and a straight line examined from a predetermined reference point. Next, the processor 106 may calculate a distance between the reference point and the intersection to calculate the derived distance map. The derived distance map may be calculated for each angle with a predetermined reference point as a starting point, and may be calculated for each predetermined equiangular bin, for example. That is, the derived distance map may include a radial distance to the cuboid box for each predetermined equiangular bin. In addition, if the cuboid box calculated by the first head includes a radial distance and an azimuth for the object on a bird's-eye view, the processor 106 may utilize this as a derived distance map.

The result of performing the second task by the second head may include information about the boundary of the free space on the radial bird's-eye view. For example, the result of performing the second task may include classes of objects on the radial bird's-eye view. For example, the result of performing the second task may include vectors for the classes of objects. Specifically, the vector for the class may include a boundary semantic vector of the boundary of the detected object. Additionally, the vector for the class of objects may be generated for each predetermined angle based on a predetermined reference point as a starting point on the bird's-eye view, and may be calculated for each predetermined equiangular bin, for example. The class vector may include information about labels such as vehicles, Vulnerable Road Users (VRUs), or others. The types of class labels included in the class vector are not limited to these examples.

Additionally, as an example, the performing result may include distance information of the boundary to the detected object. Specifically, the second head may output the distance to the nearest object boundary for each angle on the generated bird's-eye view (hereinafter, referred to as an output distance map). Specifically, the second head may output a radial distance map (RDM), which is a set of radial distances to the object boundary on the output bird's-eye view for each equiangular bin.

Next, the processor 106 calculates the inconsistency loss based on the derived distance map and the output distance map (S220). For example, the processor 106 calculates the inconsistency loss based on the derived distance map and the output distance map for an object that satisfies a predefined correlation for the similarity of classes among the objects detected by the first head and the second head. As a premise for this, the definitions of classes distinguished by multiple tasks may be different. However, a correlation such as an inclusion relationship or a connection relationship between classes may be included, and the performing results output by different tasks may include information about the distance. In other words, even if the classes distinguished by multiple tasks are not the same, they may include a correlation, and when the detected object is ideally inferred, the inference result must be consistent. For example, for an object recognized as a passenger car or a truck by the first head performing the object recognition task, the second head performing the free space estimation task must infer it as a vehicle. In addition, the derived distance map calculated by the performing result of the first head and the output distance map provided as the output of the second head must also be identical. However, since consistency cannot be determined for objects that the first head that performs an object recognition task such as a road curb does not detect, a constraint on consistency occurs only for classes that have a correlation between the performing results of the first and second heads. That is, the processor 106 calculates inconsistency loss only for objects whose classes detected by the performing results of the first and second heads satisfy a correlation predefined by system settings or user specifications.

Next, the processor 106 calculates the inconsistency loss only for objects that satisfy the constraints on the correlation for the class. The processor 106 may calculate the inconsistency loss using a task consistency loss function.

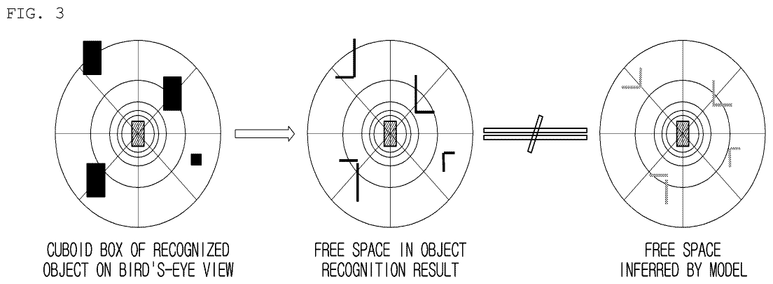

Specifically, the processor 106 computes a loss based on a scalar value of the derived distance map and the output distance map, a loss based on the endpoint of the derived distance map and the output distance map with a predetermined reference point as a starting point, and a loss based on a per-object class satisfying a correlation. The output results of each task of a deep learning model performing multiple tasks must be consistent. However, the results of the first head performing an object recognition task and the performing results of the second head performing a free space estimation task may have some differences, as shown in FIG. 3. FIG. 3 is a diagram visually showing a difference caused by a calculated derived distance map and an output distance map.

Referring to FIG. 3, there is a difference between the free space defined by the cuboid box on the radial bird's-eye view output by the first head and the free space on the radial bird's-eye view output by the second head. Based on the difference that occurs as shown in FIG. 3, the processor 106 may calculate a loss and train an artificial intelligence model to perform a task that maintains consistency based on this.

Returning to FIG. 2, the loss based on the scalar value may include, for example, a radius loss. For example, the processor 106 may calculate the radius loss through an intersection-over-union of the derived distance map and the output distance map. Specifically, the processor 106 calculates the radius loss using [Equation 1] below.

$${L}_{fsp}^{iou} ( \hat{r} , r ) = 1. - {\prod }_{i = 1}^{{N}_{bins}} \frac{min ( {r}_{i} , {\hat{r}}_{i} )}{max ( {r}_{i} , {\hat{r}}_{i} )} . \qquad [ Equation 1 ]$$

For example, rᵢ may represent a scalar value of the output distance map, i.e., the radial distance. [symbol] may mean a scalar value of the derived distance map, i.e., the radial distance. N_{bins} may mean the length of the radial distance vector divided into a predetermined equiangular bin (i.e., the total number of equiangular bins).

The loss based on the endpoints of the derived distance map and the output distance map with the predetermined reference point as the starting point may include, for example, similarity loss. For example, the processor 106 may calculate the similarity loss through the difference between vectors formed by connecting the endpoints of vectors determined by the radial distance and the radial angle included in the derived distance map and the output distance map with the predetermined reference point as the starting point, for each consecutive equiangular bin. Specifically, the processor 106 calculates the similarity loss using [Equation 2] below.

$${L}_{fsp}^{sim} ( \hat{r} , r ) = {\sum }_{i = 1}^{{N}_{bins}} ( 1. - \frac{{\hat{l}}_{i}^{i + 1} \cdot {l}_{i}^{i + 1}}{‖ {\hat{l}}_{i}^{i + 1} ‖ ‖ {l}_{i}^{i + 1} ‖} ) ,$$

$${\hat{l}}_{i}^{i + 1}$$

denotes a vector connecting the endpoints of vectors determined by the radial distance and the radial angle of the derived radial distance, which are formed according to consecutive equiangular bins. Similarly,

$${l}_{i}^{i + 1}$$

denotes a vector connecting the endpoints of vectors determined by the radial distance and the radial angle of the output radial distance, which are formed according to consecutive equiangular bins.

The loss based on the class of each object may include, for example, a classification loss (focal loss). For example, the processor 106 may calculate the classification loss based on the class probability of an object satisfying the correlation. Specifically, the processor calculates the loss based on the class of each object based on [Equation 3] below.

$${L}_{fsp}^{clc} ( \hat{c} , c ) = {\sum }_{i = 1}^{{N}_{bins}} {\sum }_{j = 1}^{C} {( 1 - {p}_{ij} )}^{γ} log ( {p}_{ij} ) , \qquad [ Equation 3 ]$$

γ represents a focal loss parameter, which may assign importance to the loss that occurs according to the probability of a specific class.

Finally, the processor 106 calculates the inconsistency loss (L_{con}(tᵢ,tⱼ)) based on at least one of the losses obtained by the above-described process. For example, the inconsistency loss (L_{con}(tᵢ,tⱼ)) may be calculated by adding the loss based on the scalar value, the loss based on the endpoint, and the loss based on the class obtained by the above-described process according to a predetermined ratio.

Next, the processor 106 reflects the inconsistency loss to the loss of the artificial intelligence model (S230). The loss of the artificial intelligence model performing general multi-tasks may be presented in the form of a weighted sum of losses caused by loss functions of individual tasks. For example, the loss of the artificial intelligence model may be determined by adding a weight wₜ to the loss

$${L}_{t}^{b}$$

caused by Individual tasks by a predetermined ratio, such as

$${L}_{total} = {\sum }_{t = 1}^{T} {w}_{t} {L}_{t}^{b} .$$

The processor 106 reflects the inconsistency loss to the loss of the artificial intelligence model as in [Equation 4] below to derive consistent inference during learning of the artificial intelligence model.

$${L}_{total} = {\sum }_{t = 1}^{T} {w}_{t} {L}_{t}^{b} + {L}_{con} ( {t}_{i} , {t}_{j} )$$

Meanwhile, the processor 106 may adjust the ratio with the loss of the artificial intelligence model by giving a certain weight to the inconsistency loss.

Next, the processor 106 sets the artificial intelligence model to be trained using the loss reflecting the inconsistency (S240). The processor 106 may build a pipeline to perform steps S210 and S240, and control the learning unit 114 to train the artificial intelligence model based on the built pipeline.

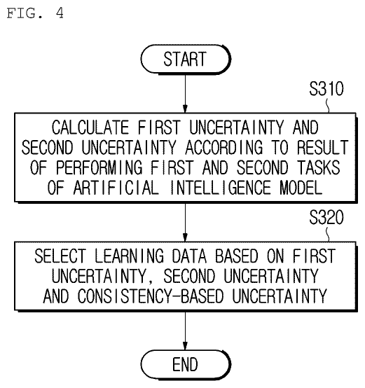

The processor 106 may modularize and distribute an artificial intelligence model whose learning has been completed, and build a pipeline for updating the artificial intelligence model using selected data acquired through the collection module 116 including the artificial intelligence model. In addition, the processor 106 may secure selected data as learning data based on the built pipeline. This will be described in detail using FIG. 4.

FIG. 4 is a flowchart illustrating the process of selecting learning data for training an artificial intelligence model in a pipeline, as described in this disclosure. Hereinafter, the process of selecting the learning data will be explained on the assumption that the collection module 116 is distributed to the mobility device 300. The collection module 116 may be processed within the server 100 without being distributed to a separate device, such as the mobility device 300.

The collection module 116 calculates a first uncertainty and a second uncertainty according to the results of performing the first and second tasks of the artificial intelligence model (S310). For example, the first head of the artificial intelligence model performing the first task may additionally be provided with a head that calculates uncertainty. For example, the cuboid box uncertainty may be calculated from the first head performing an object recognition task as the first task. For example, the collection module 116 may model the first uncertainty based on the distribution for the class obtained according to the results of performing the task of the first head and the cuboid box uncertainty. Specifically, the collection module 116 may quantify the uncertainty by combining the cuboid box uncertainty and the uncertainty calculated from the distribution over the classes. For instance, the collection module 116 may calculate the uncertainty using the logarithm of the probability for each class from the class distribution. Additionally, it may calculate the Shannon entropy of the distribution. Next, the collection module 116 models the first uncertainty by combining the cuboid box uncertainty and the uncertainty calculated from the distribution over the classes according to a predetermined ratio.

The collection module 116 may calculate the second uncertainty based on at least one of the uncertainty about the boundary of an object on a bird's-eye view output from the second head that performs a free space estimation task as a second task or a distribution of a class of an object indicated by the boundary. For instance, the second head may include an additional head to calculate the uncertainty about the boundary. In addition, as an example, the collection module 116 may transform a class vector obtained according to a task performing result of the second head into information about a distribution, and may calculate the uncertainty based on a log value of a probability for each class and the probability. As an example, the collection module 116 may model the second uncertainty based on a task performing result of the second head through a substantially same method as a method of obtaining the first uncertainty. For example, the collection module 116 may calculate the Shannon entropy of a distribution transformed from a class vector.

Next, the collection module 116 selects learning data based on the first uncertainty, second uncertainty, and consistency-based uncertainty (S320). The consistency-based uncertainty may be calculated in the same way as the consistency loss function. Through the consistency loss function, it is possible to robustly select inference results that are clearly wrong compared to active learning methodologies through separate modeling for uncertainty.

For example, the consistency-based uncertainty may be calculated based on at least one of an uncertainty based on scalar value of the derived distance map and output distance map obtained from the learned artificial intelligence model, an uncertainty based on an endpoint of the derived distance map and output distance map with a predetermined reference point as the starting point, and an uncertainty based on a corresponding class.

The collection module 116 may select data input to an artificial intelligence model as learning data if at least one of the first uncertainty, the second uncertainty, or the in consistency-based uncertainty is greater than a predetermined threshold.

For example, if the collection module 116 is distributed to the mobility device 300, the learned artificial intelligence model of the collection module 116 may perform a task by receiving video data acquired from the sensor unit 202 mounted on the mobility device 300 as input. Next, the collection module 116 determines whether at least one of the first uncertainty, the second uncertainty, and the consistency-based uncertainty acquired by the first and second task performing results for each video data is greater than a predetermined threshold. For example, if the first uncertainty probability according to the first task performing result based on specific video data is greater than a predetermined threshold, the collection module 116 may select the specific video data and store it as learning data. Alternatively, if the second uncertainty probability according to the second task performing result based on the specific video data is greater than or equal to a predetermined threshold, the collection module 116 may select the specific video data and store it as learning data. Alternatively, even if the first and second uncertainty probabilities according to the first and second task performing results based on the specific video data are less than a predetermined threshold, if the consistency-based uncertainty is greater than or equal to a predetermined threshold, the collection module 116 may select the specific video data and store it as learning data. As a result, the acquired metric does not require additional labeling, thereby eliminating annotation costs.

Additionally, by extending uncertainty-based active learning in general single-task performing AI models, it is possible to save annotation costs by selecting data that is advantageous to learning from the learning data collection step, through learning data selection logic that combines uncertainty and consistency for each task of an artificial intelligence model performing multiple tasks.

Additionally, learning data for further training of the artificial intelligence model may be selected solely from the results of the artificial intelligence model in the collection module 116. This approach reduces computational requirements compared to methods that predict loss during the inference step for active learning, thereby ensuring real-time performance. Hereinafter, for convenience of understanding, an embodiment in which the learning module 108 and the collection module 116 operate based on the pipeline described above through FIG. 6 will be described. FIG. 6 is a diagram exemplifying an artificial intelligence model learning process and a learning data collection process to which a pipeline according to the present disclosure is applied.

The structure of the artificial intelligence model illustrated in FIG. 6 is a schematic diagram according to one embodiment, and the artificial intelligence model of the present disclosure is not limited to the illustrated structure and may be equipped with additional heads for each type of task that may be performed.

The learning data is transformed into a feature map or bird's eye view feature by the encoder of the artificial intelligence model, and the first and second heads may perform the first and second tasks based on the output of the encoder. Next, the artificial intelligence model is trained using the inconsistency loss derived from the task results of the first and second heads, along with the loss of the model calculated using the results and ground truth data for each head.

The trained artificial intelligence model may be included in the collection module 116 and distributed. The artificial intelligence model of the collection module 116 may perform a task. In addition, the collection module 116 selects learning data from among the input data based on the first and second uncertainties and consistency-based uncertainty that occur according to the performing result. For example, the collection module 116 may additionally have a selection module that may perform step S320 of FIG. 4. The collection module 116 may store the selected learning data and transmit the stored learning data according to a request in the future.

FIG. 7 is a diagram illustrating a mobility device communicating with another device to transmit and receive data.

The mobility device 300 may refer to a device that may move to a specific point, as described above in FIG. 1. In the present disclosure, the mobility device 300 is described as a vehicle that runs on the ground, but the present disclosure may also be applied to a mobility device for flying or water transportation. The mobility device 300 may be controlled and driven autonomously, as described above in FIG. 1, and the autonomous driving may be implemented as semi-autonomous driving or fully autonomous driving.

The mobility device 300 may be driven by electric energy or fossil energy. In the case of electric energy, the mobility device 300 may employ, for example, a pure battery-based vehicle driven only by a high-voltage battery or a gas-based fuel cell as an energy source. In addition, the fuel cell may utilize various forms of gas capable of generating electric energy, and the gas may be, for example, hydrogen. However, the disclosure is not limited thereto, and various gases may be applied. In the case of fossil energy, the mobility device 300 is driven by fuel such as gasoline, diesel, or liquefied gas, and may be equipped with an engine that drives a wheel drive unit 214 by combustion of the fuel. The engine may be included in a power source unit 212 in terms of providing the driving rotational force of the wheel to the wheel drive unit 214. Alternatively, the mobility device 300 may be powered by a hybrid system using both electric and fossil energy.

Meanwhile, the mobility device 300 may communicate with other devices, such as the server 100, the ITS device 200, or another mobility device 400. For instance, the server 100 supports various controls, status management, and driving of the mobility device 300, while the ITS device 200 receives information from an Intelligent Transportation System (ITS) and other user devices. The server 100 may be, for example, an external device operated by a vehicle manufacturer or a management organization that provides autonomous driving services, as described above in FIG. 1.

The ITS device 200 is, for example, a road side unit (RSU), and the ITS device 200 may exchange vehicle recognition data, driving control and status data, environmental data around the vehicle, map data, etc. with the mobility device 300 via V2I to assist the user's ego-vehicle driving or support autonomous driving of the mobility device 300. The mobility device 300 may exchange the data listed above with another mobility device 400 via V2V to support ego-vehicle driving or autonomous driving.

The mobility device 300 may communicate with other vehicles or devices using cellular communication, WAVE (Wireless Access in Vehicular Environments), DSRC (Dedicated Short-Range Communication), or other communication methods. For example, the mobility device 300 may use a cellular communication network such as LTE or 5G, a Wi-Fi communication network, or a WAVE communication network for communication with the server 100, the ITS device 200, and another mobility device 400. As another example, DSRC or the like used in the mobility device 300 may be used for communication between vehicles. The communication method among the mobility device 300, the server 100, the ITS device 200, another mobility device 400, and the user device is not limited to the above-described embodiment.

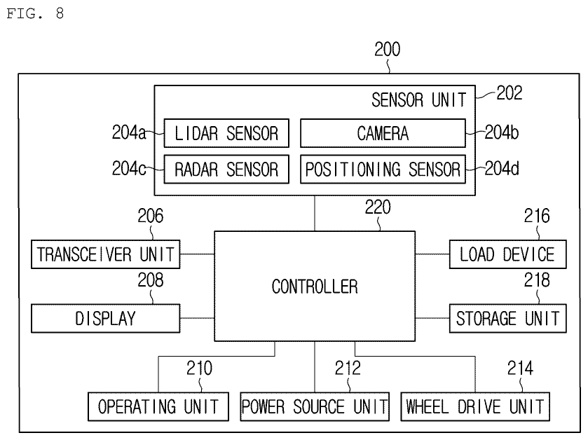

FIG. 8 is a diagram schematically showing modules constituting a mobility device according to the present disclosure. The mobility device 300 of FIG. 8 exemplifies a ground vehicle.

The mobility device 300 may include a sensor unit 202, a transceiver unit 206, and a display 208.

The sensor unit 202 may be equipped with various types of detectors that detect various states and situations occurring in the external and internal environments of the mobility device 300 and determine location information of the mobility device 300. That is, the sensor unit 202 is configured as a multi-sensor module including heterogeneous sensors, and may acquire sensing data detected from each sensor.

Specifically, the sensor unit 202 may have a lidar sensor 204a, a camera 204b functioning as an image sensor, a radar sensor 204c to recognize dynamic and static objects existing around the mobility device 300, and a positioning sensor 104d to acquire location information of the vehicle. The sensor unit 202 may acquire sensor data including 3D recognition data, perception observation data, and location data by the above-described sensors.

The lidar sensor 204a observes the surrounding environment using laser scanning and detects the three-dimensional shape of objects. The camera 204b may acquire two-dimensional image data or images (or image data) having depth information of the surrounding environment or objects of the mobility device 300 in a time-series manner. The camera 204b may be installed in multiple parts of the mobility device 300, so that multiple images or multi-views of the surrounding environment of the mobility device 300 may be acquired. That is, the camera 204b may acquire information about the surrounding environment not only in a time-series manner but also continuously from the perspective of the mobility device 300.

The radar sensor 204c may, for example, irradiate radio waves with a predetermined wavelength to the surroundings and detect the behavior of the object based on the radio waves reflected from the object. The behavior of the object may include, for example, the presence or absence of the object, movement of the object, the distance between the mobility device 300 and the object, the speed of the object, the direction of movement, etc.

The sensor unit 202 may be equipped with, in addition to the positioning sensor 104d, a gyro sensor, an acceleration sensor, a wheel sensor, an odometer, a speed sensor, etc., to check its own position, driving attitude, and speed. Additionally, the sensor unit 202 may include an inward-facing image sensor, a biometric sensor to detect signals from the driver and passengers, and various detection modules to monitor the status of users and passengers inside the mobility device 300 and the operational status of internal vehicle devices operable by the user.

In the present disclosure, the sensors of the sensor unit 202 referred to in the description of the embodiment are mainly described, but sensors that detect various situations not listed therein may be additionally included.

The transceiver unit 206 may support mutual communication with the server 100 and the mobility device 300 around the ITS device 200. In the present disclosure, the transceiver unit 206 may transmit data generated or stored during driving to the server 100, and receive data and software modules transmitted from the server 100. In the present disclosure, the mobility device 300 may transmit and receive data utilized in the method according to the present disclosure to and from the outside via the transceiver unit 206.

The display 208 may function as a user interface. The display 208 may display, by a controller 106, the operating status of the mobility device 300, the control status, the route/traffic information, the remaining energy information, the content requested by the driver, etc. The display 208 is a touchscreen designed to detect the driver's input and may forward the driver's requests to the processor 106.

The mobility device 300 may include an operating unit 210, a power source unit 212, a wheel drive unit 214, and a load device 216.

The operating unit 210 has at least one module that implements a driving motion, and may perform at least one driving motion among longitudinal control such as acceleration/deceleration and lateral control such as steering. The operating unit 210 may have various operating modules for causing the wheel drive unit 214 to generate a driving motion according to the request, including a pedal, a steering wheel, etc. that receive a user's request for the control.

The power source unit 212 may generate and supply power and electric power used for a driving power system such as the wheel drive unit 214 and the load device 216. If the mobility device 300 is driven based on electric energy, the power source unit 212 may be composed of, for example, an electric battery, or a combination of an electric battery and a fuel cell that charges the battery. In the case of a combination of an electric battery and a fuel cell, the power source unit 212 may include a tank that stores a material used to generate electric power for the fuel cell, for example, hydrogen gas. If the mobility device 300 operates on fossil energy, the power source unit 212 may be composed of an internal combustion engine.

The wheel drive unit 214 may include a plurality of wheels, a driving force transmission module for generating driving force and applying or transmitting the driving force to the wheels, a braking module for decelerating the driving of the wheels, and a steering module for realizing lateral control of the wheels. If the mobility device 300 operates on electric energy, the driving force transmission module may be composed of a motor module for generating driving force based on power output from an electric battery. If the mobility device 300 is operated based on fossil energy, the driving force transmission module may have a transmission or gear module for transmitting power of an internal combustion engine.

In the present disclosure, the operating unit 210 and the wheel drive unit 214 may constitute an actuating unit that transmits power generated from the power source unit 212 to externally implement driving motions and postures, etc. In the present disclosure, the actuating unit is referred to as an actuator, and these terms may be used interchangeably.

The load device 216 is mounted on the mobility device 300 and may be an auxiliary device that consumes power supplied from the power source unit 212 or power transformed from the output of the power source unit 212 by use by a passenger or a user. The load device 216 may be a type of non-driving electric device excluding a driving power system such as the wheel drive unit 214 in the present disclosure. The load device 216 may be, for example, an air conditioning system, a lighting system, a seat system, and various devices installed on the mobility device 300.

In addition, the mobility device 300 may include a storage unit 218 and a controller 220.

The storage unit 218 stores applications and various data for controlling the mobility device 300, and may load applications or read and record data at the request of the controller 220. In the present disclosure, the storage unit 218 may receive and manage the collection module 116, etc. from the server 100. In addition, the storage unit 218 may receive and manage information necessary for driving, such as map information, traffic information, weather information, and accident information.

The controller 220 may perform overall control of the mobility device 300. The controller 220 is configured to execute applications and instructions stored in the storage unit 218. The controller 220 may utilize the output result of the collection module 116 together with various data recognized from the lidar sensor 204a, the camera 204b, the radar sensor 204c and the positioning sensor 204d for autonomous driving control. Specifically, the controller 220 may utilize the performing result obtained by the collection module 116 for autonomous driving control.

In the present disclosure, the controller 220 may be implemented as a single processing module, for example. As another example, the processing according to the above-described matters may be distributed and processed in a plurality of processing modules, and the controller 220 may be referred to collectively as a plurality of processing modules in the present disclosure.

According to the present disclosure, it is possible to provide a method and apparatus for building an artificial intelligence model pipeline based on multi-task consistency, which builds a pipeline for designing an artificial intelligence model by utilizing loss and uncertainty based on the consistency between output results of tasks.

Additionally, in MTL, negative transfer that degrades individual task performance due to task correlation can be mitigated. In addition, by quantifying the consistency between the output results of related tasks (task consistency) and reflecting it during learning, the shared parameters of the model to which the MTL methodology is applied can be derived to learn sufficient information about constraints between tasks.

In addition, an active learning pipeline can be designed and provided that determines whether to collect data to be used as learning data by utilizing uncertainty and inconsistency of individual tasks from the inference results of a model to which the distributed MTL methodology is applied, and repeats learning using the collected data.

In addition, the annotation cost for learning an MTL model can be minimized by the pipeline provided according to the present disclosure.

In addition, since additional information on uncertainty can be provided when utilizing the output value of the cognitive module in the determination and control stages of autonomous driving, it can be utilized for functions such as reliability adjustment between sensors and disabling autonomous driving logic in case of an emergency.

It will be appreciated by person skilled in the art that that the effects that can be achieved through the present disclosure are not limited to what has been particularly described hereinabove and other advantages of the present disclosure will be more clearly understood from the detailed description.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of this disclosure includes software or machine-executable commands (e.g., an operating system, application, firmware, or program) that enable operations according to the described methods to be executed on an apparatus or computer, as well as a non-transitory computer-readable medium storing such software or commands for execution on the apparatus or computer.

What is claimed is:

1. A method of building a model pipeline, the method comprising using a processor configured to:
calculate a derived distance map of an object detected by a first head performing a first task and calculate an output distance map of the object detected by a second head performing a second task;
determine an inconsistency loss based on the derived distance map and the output distance map;
reflect the inconsistency loss to a loss of an artificial intelligence model performing the first task and the second task; and
set parameters of the artificial intelligence model to be modified based on the loss reflecting the inconsistency.

2. The method of claim 1, further comprising using the processor to:
calculate a first uncertainty and a second uncertainty based on results of performing the first and second tasks of the artificial intelligence model; and
select learning data based on at least one of the first uncertainty, the second uncertainty or a consistency-based uncertainty,
wherein the consistency-based uncertainty is determined based on the derived distance map and the output distance map.

3. The method of claim 1, wherein the derived distance map is calculated using angular measurements relative to a cuboid box representing the object on a bird's-eye view output generated by the first head, using the processor.

4. The method of claim 1, wherein the output distance map includes a distance to a nearest object for each angle on a bird's-eye view generated by the second head, using the processor.

5. The method of claim 4, wherein the determining the inconsistency loss comprises calculating the inconsistency loss based on the output distance map and the derived distance map for the object satisfying a predefined correlation for a similarity of a class among objects detected by the first head and the second head, using the processor.

6. The method of claim 1, wherein the inconsistency loss is determined based on at least one of: a loss derived from a scalar value of the derived distance map and the output distance map, a loss calculated from an endpoint of the derived distance map and the output distance map with a predetermined reference point as a starting point, and a loss based on a similarity or relationship between corresponding classes of objects, using a processor.

7. The method of claim 2, wherein the first uncertainty is determined based on an uncertainty about geometry of a cuboid box on a bird's-eye view output generated by the first head and a distribution of a class of the object to which the cuboid box refers, using the processor.

8. The method of claim 2, wherein the second uncertainty is determined based on at least one of an uncertainty about a boundary of the object on a bird's-eye view output generated by the second head or a distribution of a class of the object to which the boundary refers, using the processor.

9. The method of claim 2, wherein the consistency-based uncertainty is determined, by the processor, based on at least one of an uncertainty based on a scalar value of the derived distance map and the output distance map, an uncertainty based on an endpoint of the derived distance map and the output distance map with a predetermined reference point as a starting point, and an uncertainty derived from a corresponding class.

10. The method of claim 2, wherein the selecting the learning data comprises selecting data input to the artificial intelligence model as the learning data when at least one of the first uncertainty, the second uncertainty, or the consistency-based uncertainty is greater than or equal to a predetermined threshold, using the processor.

11. An apparatus for building a model pipeline, the apparatus comprising:
a memory configured to store at least one instruction; and
a processor configured to execute the at least one instruction stored in the memory based on data acquired from the memory,
wherein the processor is configured to:
calculate a derived distance map of an object detected by a first head performing a first task and calculate an output distance map of the object detected by a second head performing a second task;
determine an inconsistency loss based on the derived distance map and the output distance map;
reflect the inconsistency loss to a loss of an artificial intelligence model performing the first task and the second task; and
set parameters of the artificial intelligence model to be modified based on the loss reflecting the inconsistency.

12. The apparatus of claim 11, wherein the processor is configured to:
calculate a first uncertainty and a second uncertainty based on results of performing the first and second tasks of the artificial intelligence model; and
select learning data based on at least one of the first uncertainty, the second uncertainty or a consistency-based uncertainty,
wherein the consistency-based uncertainty is determined based on the derived distance map and the output distance map.

13. The apparatus of claim 11, wherein the derived distance map is calculated using angular measurements relative to a cuboid box representing the object on a bird's-eye view output generated by the first head, using the processor.

14. The apparatus of claim 11, wherein the output distance map includes a distance to a nearest object for each angle on a bird's-eye view generated by the second head, using the processor.

15. The apparatus of claim 11, wherein the processor is configured to determine the inconsistency loss based on the derived distance map and the output distance map for the object satisfying a predefined correlation for a similarity of a class among objects detected by the first head and the second head.

16. The apparatus of claim 11, wherein the inconsistency loss is determined, by the processor, based on at least one of: a loss derived from a scalar value of the derived distance map and the output distance map, a loss calculated from an endpoint of the derived distance map and the output distance map with a predetermined reference point as a starting point, and a loss based on a similarity or relationship between corresponding classes of objects.

17. The apparatus of claim 12, wherein the first uncertainty is determined based on an uncertainty about geometry of a cuboid box on a bird's-eye view output generated by the first head and a distribution of a class of the object to which the cuboid box refers, using the processor.

18. The apparatus of claim 12, wherein the second uncertainty is determined, by the processor, based on at least one of an uncertainty about a boundary of the object on a bird's-eye view output generated by the second head or a distribution of a class of the object to which the boundary refers.

19. The apparatus of claim 12, wherein the consistency-based uncertainty is determined, by the processor, based on at least one of an uncertainty based on a scalar value of the derived distance map and the output distance map, an uncertainty based on an endpoint of the derived distance map and the output distance map with a predetermined reference point as a starting point, and an uncertainty derived from a corresponding class.

20. The apparatus of claim 12, wherein the processor is configured to select data input to the artificial intelligence model as the learning data when at least one of the first uncertainty, the second uncertainty, or the consistency-based uncertainty is greater than or equal to a predetermined threshold.
